(19) United States
(12) Patent Application Publication
(10) Pub. No.: US 2016/0154161 A1
(43) Pub. Date: Jun. 2, 2016

(54) ILLUMINATION DEVICE HAVING BENT LIGHT DIFFUSING FIBERS

(71) Applicant: HON HAI PRECISION INDUSTRY CO., LTD., New Taipei (TW)

(72) Inventor: JEN-TSORNG CHANG, New Taipei (TW)

(21) Appl. No.: 14/586,084

(22) Filed: Dec. 30, 2014

(30) Foreign Application Priority Data
Nov. 28, 2014 (CN) 201410701865.0

(51) Int. Cl. F21V 8/00

(52) U.S. Cl. CPC G02B 6/001; G02B 6/0006; G02B 6/0096

(57) ABSTRACT

An illumination device includes a first light diffusing fiber, a first light source coupled to the first light diffusing fiber, a second light diffusing fiber, and a second light source coupled to the second light diffusing fiber. The first light diffusing fiber and the second light diffusing fiber each is configured to guide light along its length and scatter guided light through the periphery outer surface to have a radiation over its length. The first light diffusing fiber is stacked with the second light diffusing fiber.

### FIELD

The subject matter herein generally relates to a light emitting device, especially relates to an illumination device having bent light diffusing fibers.

### BACKGROUND

A typical illumination device includes a substrate, a light source mounted on the substrate, and a light diffusion board located on light paths of the light source. The light source includes a plurality of light emitting diodes to form an array, which can be costly.

### BRIEF DESCRIPTION OF THE DRAWINGS

Implementations of the present technology will now be described, by way of example only, with reference to the attached figures.

FIG. 1 illustrates an exemplary embodiment of an illumination device having a plurality of light-diffusing fibers optically coupled to light sources respectively.

FIG. 2 is a diagrammatic view illustrating a light source optically coupled to a light diffusing fiber via an optical coupler in an exemplary embodiment.

FIG. 3 is a diagrammatic view illustrating a light source optically coupled to a light diffusing fiber via an optical coupler in another exemplary embodiment.

FIG. 4 illustrates a second exemplary embodiment of an illumination device having a plurality of light diffusing fibers optically coupled to light sources respectively.

FIG. 5 illustrates a third exemplary embodiment of an illumination device having a plurality of light diffusing fibers optically coupled to light sources respectively.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

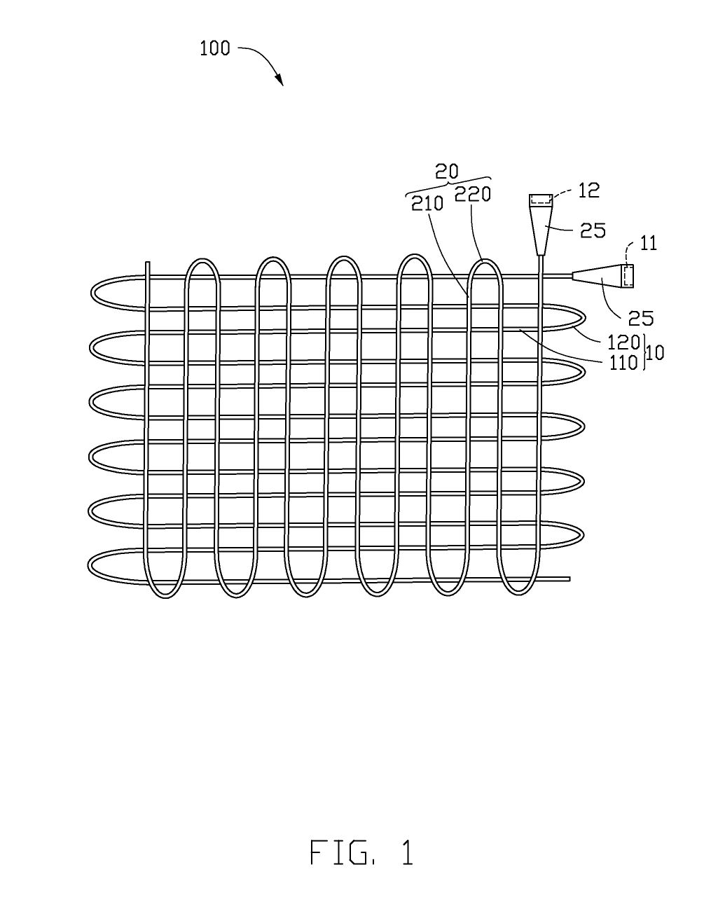

FIG. 1 illustrates an exemplary illumination device 100 having a first light diffusing fiber 10, a second light diffusing fiber 20, a first light source 11 optically coupled to an end of the first light diffusing fiber 10 via an optical coupler 25, a second light source 12 optically coupled to an end of the second light diffusing fiber 20 via the other optical coupler 25. The first light diffusing fiber 10 is bent several times, and the second light diffusing fiber 20 is bent several times also. The first light diffusing fiber 10 is stacked with the second light diffusing fiber 20. The first light diffusing fiber 10 and the second light diffusing fiber 20 each are configured to scatter guided light through the periphery outer surface, and to have a length that emits uniform radiation over its length.

Optionally, the first light diffusing fiber 10 can be straight, bent once, bent twice or bent more than twice. The first light diffusing fiber 10 can be bent in a first plane. In this embodiment, the first light diffusing fiber 10 bends for 11 times.

The first light diffusing fiber 10 includes a plurality of straight portions 110 and a plurality of connecting portions 120. The connecting portions 120 each is located between two adjacent straight portions 110. Optionally, the straight portions 110 of the first light diffusing fiber 10 are parallel with each other. The straight portions 110 can be equidistantly spaced from each other. The connecting portions 120 each has an arc-shaped configuration.

The first light diffusing fiber 10 conducts the light from the first light source 11 along its length direction, and scatters the light to outer periphery surface of the first light diffusing fiber 10. The first light source 11 can be a light emitting diode or a laser. The first light source 11 emits a first light with a first color. In this embodiment, the first light source 11 is a blue light emitting diode or a blue laser which emits blue light.

Optionally, the second light diffusing fiber 20 can be straight, bent once, bent twice or bent more than twice. The second light diffusing fiber 20 can be bent in a second plane which can be parallel with the first plane where the first light diffusing fiber 10 is. In this embodiment, the second light diffusing fiber 20 is bent 11 times. The second light diffusing fiber 20 includes a plurality of straight portions 210 and a plurality of connecting portions 220. The connecting portions 220 each is located between two adjacent straight portions 210. The straight portions 210 of the second light diffusing fiber 20 can be parallel with each other. The straight portions 210 can be equidistantly spaced from each other.

The connecting portions 220 each has an arc-shaped configuration. At least a part of the straight portions 210 of the second light diffusing fiber 20 is stacked with a part of the straight portions 110 of the first light diffusing fiber 10. In this embodiment, the straight portions 210 of the second light diffusing fiber 20 are perpendicular to the straight portions 110 of the first light diffusing fiber 10. The second light diffusing fiber 20 can be combined with the first light diffusing fiber 10 by transparent glues.

The second light diffusing fiber 20 conducts the light from the second light source 12 along its length direction of the second light diffusing fiber 20, and scatters the light to outer periphery surface of the second light diffusing fiber 20. The second light source 12 can be a light emitting diode or a laser. The second light source 12 emits a second light with a second color which is different from the first color from the first light source 11. In this embodiment, the second light source 11 is a red light emitting diode or a red laser which emits red light.

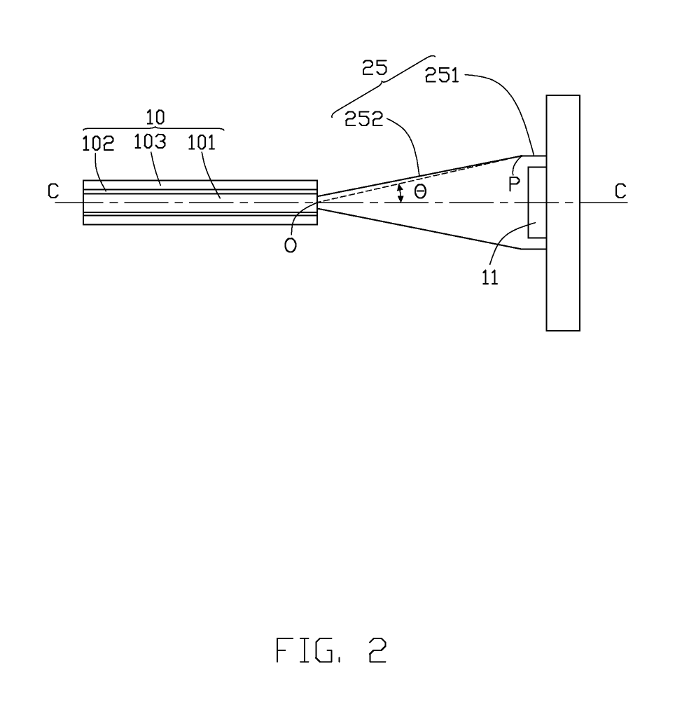

FIG. 2 illustrates the first light source 11 coupled to an end of the first light diffusing fiber 10 via an optical coupler 25.

The first light diffusing fiber 10 includes a solid central portion 101, a nano-structured ring portion 102 surrounding the solid central portion 101 and a cladding portion 103 surrounding the nano-structured ring portion 102. The cladding portion 103 can have low refractive index to provide a high numerical aperture (NA). The cladding portion 103 can be, for example, a low index polymer such as thermally curable fluoroacrylate or silicone.

The first light diffusing fiber 10 has a numerical aperture, which equals sin θ in this embodiment. The optical coupler 25 conducts light from the first light source 10 to the range of the numerical aperture.

The optical coupler 25 has a surrounding wall 251 and a light guiding tube 252. The surrounding wall 215 surrounds the first light source 10. The light guiding tube 252 extends from the surrounding wall 215 to the end of first light diffusing fiber 10. Inner diameter of the light guiding tube 252 decreases from the surrounding wall 251 to the end of the first light diffusing fiber 10. An outermost end of the light guiding tube 252 is in optical contact with the end of the first light diffusing fiber 10. In this embodiment, the outermost end of the light guiding tube 252 is in contact with the end of the first light diffusing fiber 10 which is configured to emit through by lights of the first light source 11. Preferably, the inner diameter of the outermost end of the light guiding tube 252 equals the diameter of the solid central portion 101.

Preferably, the angle θ associated with the numerical aperture of the first light diffusing fiber 10, is defined between the central axis C-C of the first light diffusing fiber 10 and a line which is through a center O of the end of the first light diffusing fiber 10 and any point P located at the junction between the surrounding wall 251 and the light guiding tube 252. Optionally, the first light source 11 is aligned with the central axis C-C of the first light diffusing fiber 10. Light from the first light source 11 is reflected by inner surfaces of the light guiding tube 252 to concentrate on the range of the numerical aperture of the first light diffusing fiber 10. Inner surfaces of the light guiding tube 252 can be coated with reflective materials.

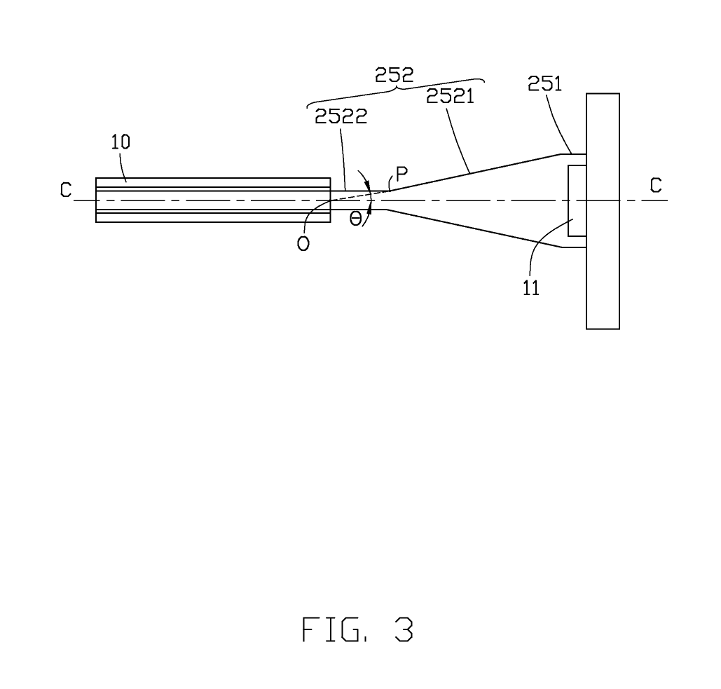

FIG. 3 illustrates the first light source 11 coupled to an end of the first light diffusing fiber 10 via another optical coupler 25. In this embodiment, the light guiding tube 252 further includes a first light guiding tube 2521 and a second light guiding tube 2522. The first light guiding tube 2521 is located between the surrounding wall 251 and the second light guiding tube 2522. Opposite ends of the first light guiding tube 2521 connects the surrounding wall 251 and the second light guiding portion 2522 respectively. An inner diameter of the first light guiding tube 2521 decreases from the surrounding wall 251 to the second light guiding tube 2522. The second light guiding tube 2521 has a uniform inner diameter. An outermost end of the second light guiding tube 2522 is in optical contact with the end of the light diffusing fiber 10.

The angle θ associated with the numerical aperture of the first light diffusing fiber 10 is defined between a central axis C-C of the first light diffusing fiber 10 and a line which is through the center O of the end of the first light diffusing fiber 10 and any point P which is located at the junction between the first light guiding tube 2521 and the second light guiding tube 2522.

The second light source 12 can be coupled to the second light diffusing fiber 20 as the first light source 11 arranged to be coupled to the first light diffusing fiber 10.

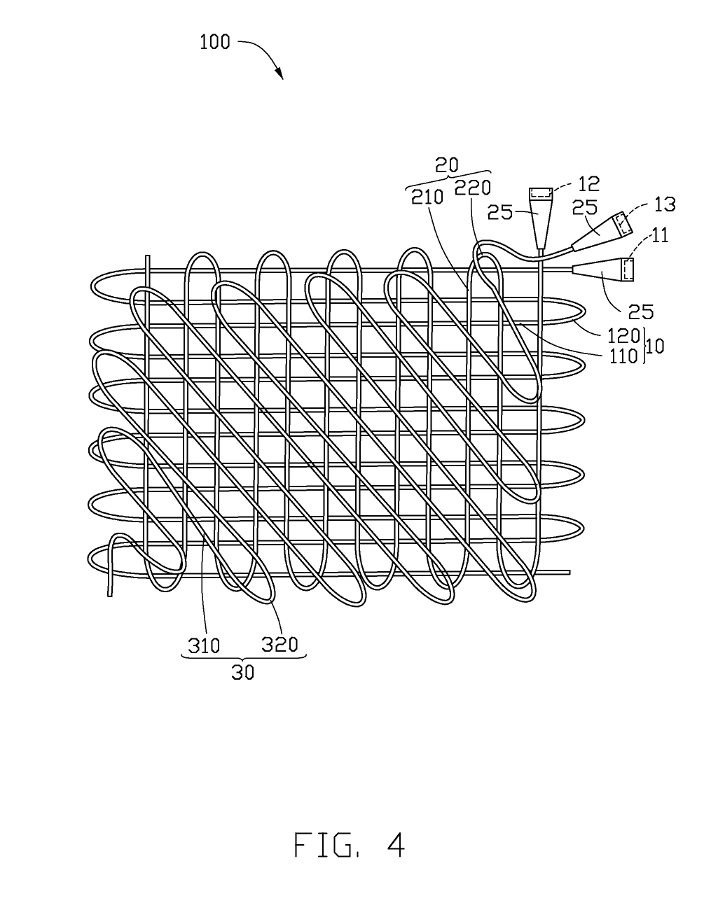

FIG. 4 illustrates a second exemplary embodiment of the illumination device 100. In this embodiment, the illumination device 100 further includes a third light diffusing fiber 30 stacked with the first and second light diffusing fibers 10, 20, and a third light source 30 coupled with the third light diffusing fiber 30 via an optical coupler 25. The third light diffusing fiber 30 is located on the second light diffusing fiber 20. The first light diffusing fiber 10, the second light diffusing fiber 20 and the third light diffusing fiber 30 can be combined with each other by glues.

The third light diffusing fiber 30 includes a plurality of straight portions 310 and a plurality of connecting portions 320. The connecting portions 320 connect each two adjacent straight portions 310 respectively. The straight portions 310 can be parallel with each other. Optionally, the straight portions 310 are equidistantly spaced from each other. The parallel straight portions 310 of the third light diffusing fiber 30 and the parallel straight portions 210 of the second light diffusing fiber 20 defines an angle, which is different from an angle defined by the parallel straight portions 210 of the second light diffusing fiber 20 and the parallel straight portions 110 of the first light diffusing fiber 10. In this embodiment, the angle defined by the parallel straight portions 310 and the parallel straight portions 210 is 45°, and the angle defined by the parallel straight portions 210 and the parallel straight portions 110 is 90°.

The third light source 13 emits a third light with a third color. The third light source 13 can be a green light emitting diode or a green laser which emits green light.

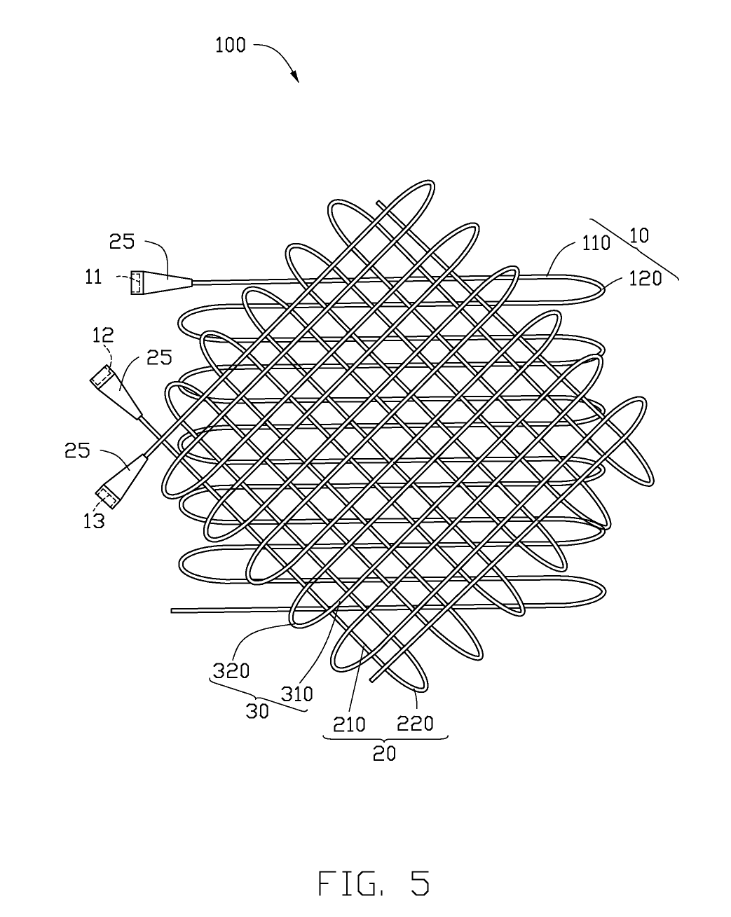

FIG. 5 illustrates a third exemplary embodiment of the illumination device 100. In this embodiment, an angle defined by the parallel straight portions 110 of the first light diffusing fiber 10 and the parallel straight portions 210 of the second light diffusing fiber 20 is 45°, and the parallel portions 310 of the third light diffusing fiber 30 is perpendicular to the parallel portions 210 of the second light diffusing fiber 20.

The embodiments shown and described above are only examples. Many details are often found in the art such as the other features of an illumination device having bent light diffusing fibers. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An illumination device comprising:
a first light diffusing fiber;
a first light source coupled to the first light diffusing fiber;
a second light diffusing fiber; and
a second light source coupled to the second light diffusing fiber, wherein the first light diffusing fiber and the second light diffusing fiber each are configured to guide light along its length and scatter guided light through the periphery outer surface to have a radiation over its length, and the first light diffusing fiber is stacked with the second light diffusing fiber.

2. The illumination device of claim 1, wherein one of the first light diffusing fiber and the second light diffusing fiber is straight, and the other is bent.

3. The illumination device of claim 2, wherein the bent light diffusing fiber is bent in a plane.

4. The illumination device of claim 1, wherein the first light diffusing fiber and the second light diffusing fiber each is bent for two or more times.

5. The illumination device of claim 4, wherein the first light diffusing fiber is bent in a first plane, and the second light diffusing fiber each is bent in a second plane.

6. The illumination device of claim 5, wherein the first plane is parallel with the second plane.

7. The illumination device of claim 4, wherein the first light diffusing fiber and the second light diffusing fiber each has a plurality of straight portions and a plurality of connecting portions connecting the straight portions.

8. The illumination device of claim 7, wherein the straight portions of the first light diffusing fiber are parallel with each other, and is stacked with the straight portions of the second light diffusing fiber.

9. The illumination device of claim 8, wherein the straight portions of the second light diffusing fiber are parallel with each other.

10. The illumination device of claim 9, wherein an angle is defined between the parallel straight portions of the first light diffusing fiber and the parallel straight portions of the second light diffusing fiber.

11. The illumination device of claim 10, wherein further comprising a third light diffusing fiber and a third light source coupled to the third light diffusing fiber, and the third light diffusing fiber is stacked with the parallel straight portions of the first light diffusing fiber and the second light diffusing fiber.

12. The illumination device of claim 11, wherein the third light diffusing fiber includes a plurality of parallel straight portions and a plurality of connecting portions connecting the parallel straight portions, and an angle defined by the parallel straight portions of the third light diffusing fiber and the parallel straight portions of the second light diffusing fiber differs from the angle defined by the parallel straight portions of the second light diffusing fiber and the parallel straight portions of the first light diffusing fiber.

13. The illumination device of claim 12, wherein the angle defined by the parallel straight portions of the first light diffusing fiber and the parallel straight portions of the second light diffusing fiber is 90°, and the angle defined by the parallel straight portions of the second light diffusing fiber and the parallel straight portions of the third diffusing fiber is 45°.

14. The illumination device of claim 12, wherein the angle defined by the parallel straight portions of the first light diffusing fiber and the parallel straight portions of the second light diffusing fiber is 45°, and the angle defined by the parallel straight portions of the second light diffusing fiber and the parallel straight portions of the third diffusing fiber is 90°.

15. The illumination device of claim 1, wherein the first light source emits a first color light which is different from the color of the light from the second light source.

16. An illumination device comprising:
a light source;
a light diffusing fiber; and
an optical coupler coupling the light source to an end of the light diffusing fiber, wherein the light diffusing fiber guides light from the light source along its length direction, and scatters the guided light to periphery outer surface of the light diffusing fiber, and the light diffusing fiber is bent for two or more times in a plane.

17. The illumination device of claim 16, wherein the optical coupler has a surrounding wall surrounding the light source and a light guiding tube, the light guiding tube extends from the surrounding wall to the end of first light diffusing fiber, and an inner diameter of the light guiding tube decreases from the surrounding wall to the end of the first light diffusing fiber.

18. The illumination device of claim 17, wherein an angle θ is defined between the central axis of the first light diffusing fiber and a line which is through a center of the end of the first light diffusing fiber and any point located at the junction between the surrounding wall and the light guiding tube, the numerical aperture of the first light diffusing fiber equals sin θ.

19. The illumination device of claim 18, wherein the light guiding tube further comprises a first light guiding tube and a second light guiding tube, the first light guiding tube is located between the surrounding wall and the second light guiding tube, an inner diameter of the first light guiding tube decreases from the surrounding wall to the second light guiding tube, the second light guiding tube has a uniform inner diameter, the angle θ is defined between the central axis of the first light diffusing fiber and a line which is through the center of the end of the first light diffusing fiber and any point which is located at the junction between the first light guiding tube and the second light guiding tube.

20. An illumination device comprising:
a light source; and
a light diffusing fiber coupled to the light source, wherein the light diffusing fiber is bent for two or more times in a same plane.
